(19) United States
(12) Patent Application Publication
(10) Pub. No.: US 2013/0240640 A1
(43) Pub. Date: Sep. 19, 2013

(54) GRASS-STOP SPRINKLER HEAD SHIELD

(71) Applicant: Gary Lee White, Bakersfield, CA (US)

(72) Inventor: Gary Lee White, Bakersfield, CA (US)

(21) Appl. No.: 13/655,025

(22) Filed: Oct. 18, 2012

Related U.S. Application Data
(60) Provisional application No. 61/685,474, filed on Mar. 19, 2012.

(51) Int. Cl. B05B 1/00

(52) U.S. Cl. 239/288

(57) ABSTRACT

A protective shield for protecting a sprinkler head is disclosed. The protective shield may have a body that defines an outer perimeter that engages the ground when installed. The outer body has a carved upper surface from the outer perimeter that proceeds upward until it reaches a ridge. This permits the lawnmower or other object to be lifted above and over the sprinkler head to protect the sprinkler head. The protective shield may be cut during installation to fit different sized sprinkler heads and also to fit adjacent to a straight pavement or a corner of the pavement. The shield also prevents overgrowth of grass that might prevent proper functioning of a pop op mechanism or sprinkler head water spray.

### CROSS-REFERENCE TO RELATED APPLICATIONS

This application claims the benefits of U.S. Pat. App. Ser. No. 61/685,474, filed on Mar. 19, 2012, the entire contests of which is expressly incorporated herein by reference.

### STATEMENT RE: FEDERALLY SPONSORED RESEARCH/DEVELOPMENT

Not Applicable

### BACKGROUND

The present invention relates to a device for preventing the growth of grass around a sprinkler head.

A plurality of sprinkler heads are installed in a field at regular interval to automatically water a lawn. Unfortunately, over a period of time, the sprinkler heads are covered with grass so that spotting the sprinkler head is difficult when mowing the lawn. As a result, the lawnmower may hit the sprinkler head and damage either the pop-up mechanism or the sprinkler head. As a result the homeowner or maintenance personnel must take time to replace the damaged sprinkler head. Also, the owner must incur a cost to replace the damaged sprinkler head. Another problem with grass growing over a sprinkler head is that the overgrown grass may prevent the head from popping up during operational use. If the sprinkler head is a non pop up sprinkler head, then the overgrown grass will block the water spray.

### BRIEF SUMMARY

The protective shield described herein addresses the needs discussed above, discussed below and those that are known in the art.

The protective shield has an outer perimeter that engages the ground when installed. An upper surface of the protective shield is curved upward from the outer perimeter to an upper ridge. The lawnmower rides over the protective shield because the upper surface lifts the lawnmower above and over the sprinkler head which is installed at the center of the protective shield. The upper end of the sprinkler head is below the upper ridge of the upper surface. After the upper ridge, the upper surface curves downward and provides an enlarged volume to receive the sprinkler head therein. An inner peripheral portion of the protection shield defines an inner diameter and an inner opening. The inner peripheral portion may be cut at predefined markings to enlarge the inner opening to fit sprinkler heads of different sizes. Moreover, the body of the protective shield may be cut so that the protective shield may abut a sidewalk or a corner of a pavement.

The benefit of the protective shield is that grass does not grow over the sprinkler head so that the sprinkler head is easy to spot while mowing the lawn. Also, since the sprinkler head is not covered with grass, overgrown grass does not interfere with the pop up mechanism and the water spray from the sprinkler head is not blocked.

More particularly, a protective shield for a sprinkler is disclosed. The shield may comprise a body having an upper surface. An outer perimeter of the upper surface may be disposed at ground level. An inner perimeter of the upper surface may be disposed below ground level. The upper surface of the shield may have a donut configuration.

The upper surface of the body has a curved configuration from the outer perimeter of the body to the inner perimeter of the body to form a donut configuration. The upper surface of the body may have a curved configuration from the outer perimeter of the body to an apex of the upper surface and also may have a cylindrical receiving volume at an interior of the shield.

The body of the shield may be fabricated from a rigid material that can be cut with a pair of scissors. The body may be fabricated from plastic.

The underside of the body may have a plurality of strengthening members.

An inner peripheral portion of the body may be cut to size to fit larger diameter sized bodies of sprinklers.

An underside surface of the inner peripheral portion may have one or more ring markings for assisting a person in cutting the inner peripheral portion to open up the central opening to fit different sized bodies of sprinklers. The ring markings may be grooves.

An outer peripheral portion of the body may be cut to abut the shield against a paved corner or sidewalk.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a top perspective view of a first embodiment of a protective shield;

FIG. 2 is a bottom perspective view of the first embodiment of the protective shield shown in FIG. 1;

FIG. 2A is a bottom perspective view of the first embodiment of the protective shield with the body cut at two places to fit a corner of the pavement;

FIG. 3 is a cross-sectional view of the protective shield shown in FIG. 1;

FIG. 4 is a top perspective view of a second embodiment of the protective shield;

FIG. 5 is a bottom perspective view of the second embodiment of the protective shield shown in FIG. 4;

FIG. 5A is a bottom perspective view of the second embodiment of the protective shield with the body cut at two places to fit the corner of the pavement; and

FIG. 6 is a cross-sectional view of the protective shield shown in FIG. 4.

### DETAILED DESCRIPTION

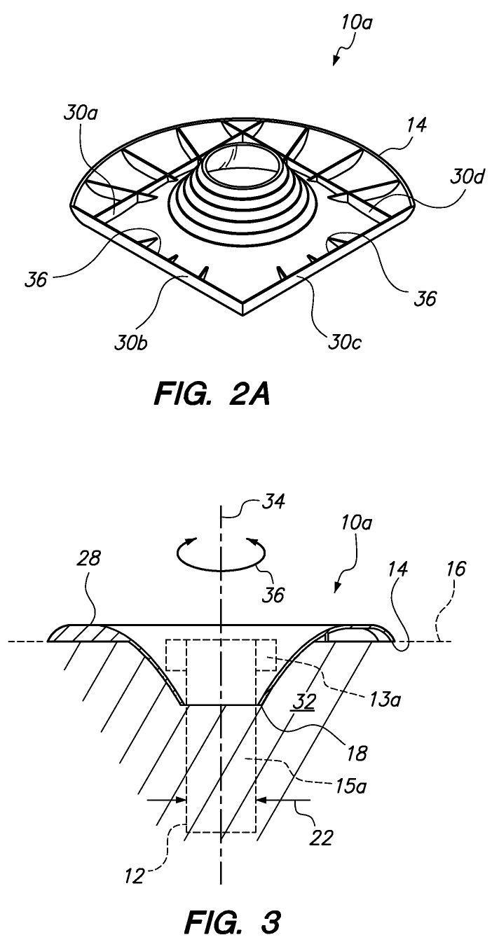

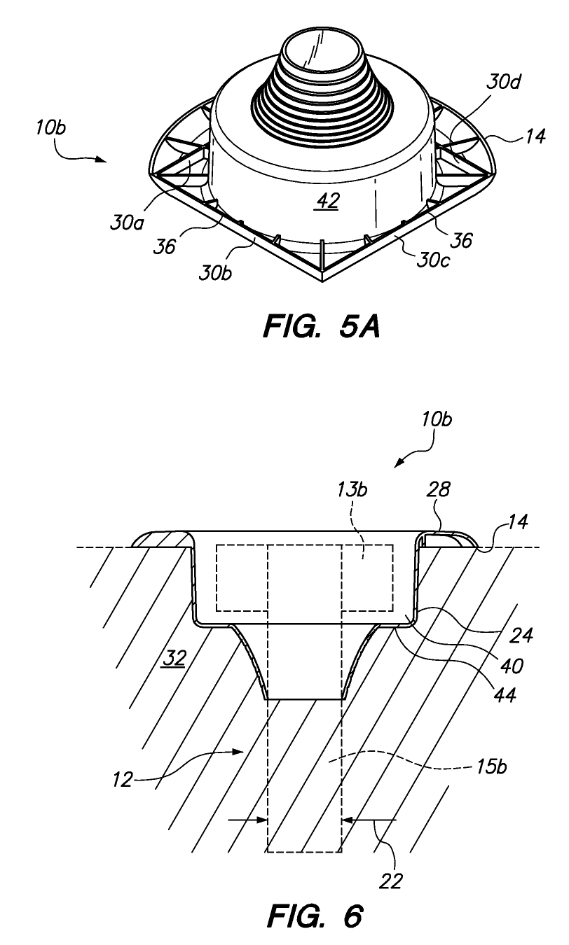

Referring now to the drawings, a protective shield 10a, b for a sprinkler 12 is shown. The protective shield 10a, b extends radially outward. An outer perimeter 14 of the shield is disposed at ground level 16 when the protective shield 10a, b and the sprinkler 12 are installed. The protective shield 10a, b covers a patch of dirt around the sprinkler 12 so that such patch of dirt does not have any sunlight and receives minimal water from the sprinkler 12 to protect grass from growing over the sprinkler 12. An inner perimeter 18 of the protective shield 10a,b has an inner diameter 20 (see FIGS. 2 and 5) slightly greater than an outer diameter 22 (see FIGS. 3 and 6) of a body 15a, b of the sprinkler 12 so that the protective shield 10a, b may receive the sprinkler 12 and be installed as shown in the drawings.

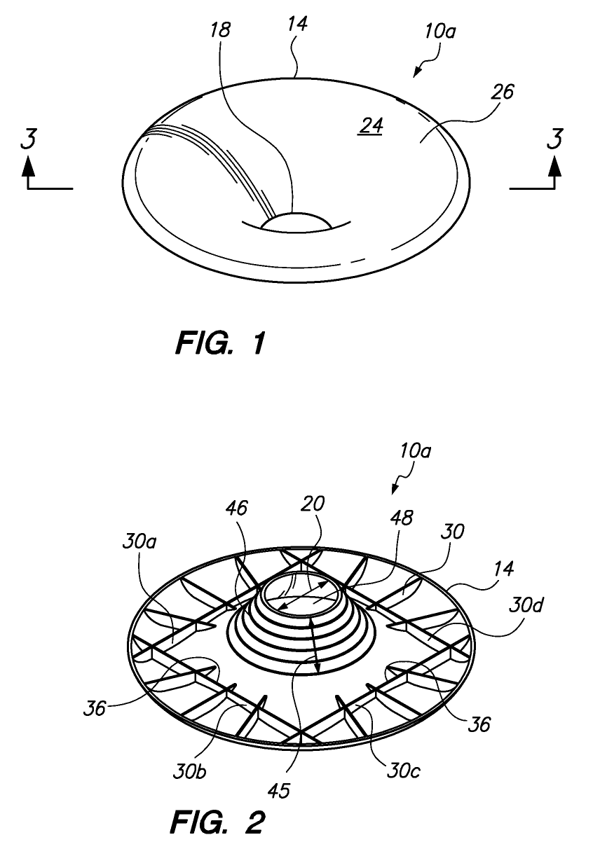

Referring now to FIG. 1, a first embodiment of the protective shield 10a is shown. The protective shield 10a has a general one-half donut configuration. In particular, an upper surface 24 of the body 26 has a curved configuration which is better shown in FIG. 3 which is a cross-sectional configuration of the protective shield shown in FIG. 1. The curved upper surface 24 extends from the outer perimeter 14 and extends to the inner perimeter 18. Upon installation of the protective shield 10a, the outer perimeter 14 engages the ground about which the sprinkler 12 is installed. The outer perimeter 14 is disposed at ground level during installation. The carved upper surface 24 proceeds above ground level 16 until the curved upper surface 24 reaches an apex or maximum height 28. In FIGS. 3 and 6, the apex 28 is shown as being a flat surface. However, it is also contemplated that the apex 28 may be a single edge of the curved upper surface 24. The curved upper surface 24 continues downward until the curved upper surface 24 reaches the inner perimeter 18.

The inner perimeter 18 is defined by an inner peripheral portion 45 (see FIG. 2) which can be cut at various markings 46 to enlarge the inner hole through which a body 15a of the sprinkler 12 is received. The markings 46 may be indentations or steps formed during the plastic injection molding process. The markings 46 could also be printed indicia formed about the circumference of the conically tapered inner peripheral portion 45. A plurality of markings 46 are shown in FIG. 5 which can be used as guides by the installer to customize the size of the inner opening 48.

Referring now to FIG. 2, an underside of the body 26 may have a plurality of stiffening members 30. The stiffening members 30 may extend from the outer perimeter 14 toward a center of the protective shield 10a. Preferably, the stiffening members 30 do not extend below ground level 16 when the protective shield 10a is installed. However, it is also contemplated that the stiffening members 30 may additionally have spikes or other protuberances that engage or pierce the ground 32 to prevent or mitigate rotational movement in the direction of arrow 36 of the protective shield 10a about central axis 34.

The underside of the body 26 may additionally have four stiffening members 30a, 30b, 30c and 30d that form a square configuration about the inner perimeter 18. When a sprinkler 12 is installed near a sidewalk or a corner of a pavement, the outer peripheral portion of the body 26 may be cut outside of any one of the stiffening members 30a, 30b, 30c, 30d so that the bottom edge of such stiffening member 30a, 30b, 30c, 30d engages the ground 32 instead of the outer perimeter 14 at that location. FIG. 2A illustrates the protective shield 10a when two sides of the body 26 are cut so that the protective shield can be aligned to the corner of a pavement. In this regard, the bottom edges 36 of the stiffening members 30b and 30c engage the ground 32 and prevent water from watering the grass underneath the protective shield 10a.

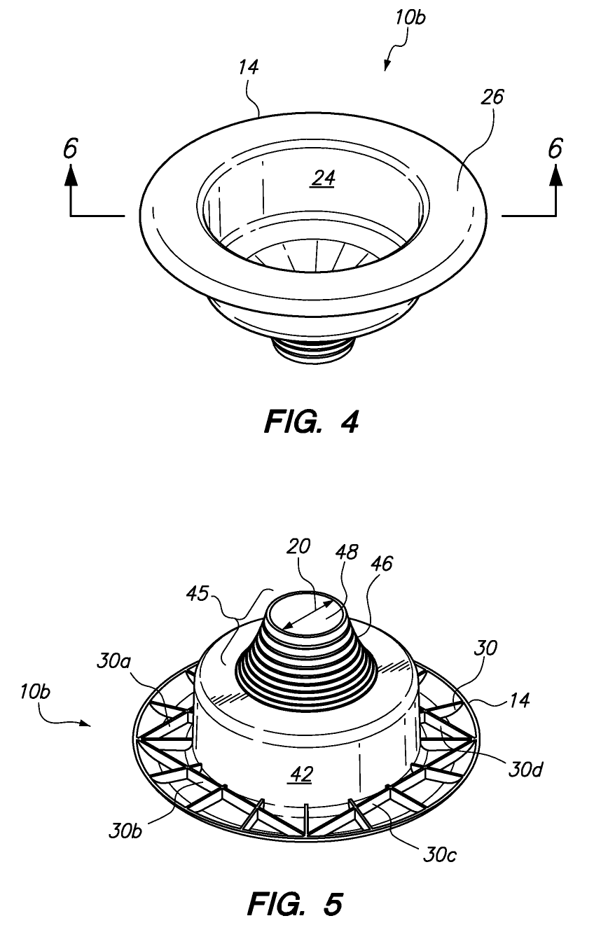

Referring now to FIGS. 4-6, a second embodiment of the protective shield 10b is shown. The protective shield 10b is substantially similar to the protective shield 10a shown in FIGS. 1-3, except that the protective shield 10b has an enlarged central volume 40. The enlarged central volume 40 is designed to fit larger size sprinkler heads 13b and yet retain all of the benefits of the embodiment of the protective shield 10a shown in FIGS. 1-3. Similar to the first embodiment of the protective shield 10a shown in FIGS. 1-3, the second embodiment of the protective shield 10b engages the ground 32 at the outer perimeter 14 of the body 20 of the protective shield 10b. The body 26 of the protective shield 10b also has an upper surface 24. The upper surface 24 may be smooth but may also have other configurations (e.g., pitted, roughened). The upper surface is generally curved beginning from the outer perimeter 14. The upper surface 24 curves upward to an apex 28. The apex 28 is shown as being a flat surface in FIG. 6. However, the apex 28 may alternatively be a single ridge. The upper surface 24 forms a vertical wall 42 having a cylindrical configuration to provide for the enlarged central volume 40 to house an enlarged sprinkler head 13b. The vertical wall 42 transitions into a flat footing 44. The flat footing 44 also transitions into a conically tapered inner peripheral portion 45 which can be cut at various markings 40 to enlarge the inner hole through which a body 15b of the sprinkler 12 is received.

The markings 46 may be indentations or steps formed during the plastic injection molding process. The markings 46 could also be printed indicia formed about the circumference of the conically tapered inner peripheral portion 45. A plurality of markings 46 are shown in FIG. 5 which can be used as guides by the installer to customize the size of the inner opening 48.

To install the protective shield 10a, b, the inner opening 48 is sized to the outer diameter of a body 15a, b of the sprinkler 12. The inner peripheral portion 45 is cut at the lowest marking 46 which permits the sprinkler body 15a, b to fit therein. The ground is excavated to fit the sprinkler 12 and (1) the inner peripheral portion 45 of the protective shield 10a or (2) the inner peripheral portion 45 and the vertical wall 42 of the protective shield 10b. The sprinkler body 15a, b is placed in the ground and the protective shield 10a or 10b is fitted over the sprinkler body 15a, b. The sprinkler head 13a, b is then mounted to the sprinkler body 15a, b. The oversized sprinkler head 13a, b keeps the shield 10a, b is place (i.e., anchored to the ground) and grass will start to grow over time around the shield 10a, b to further prevent the shield from moving. When the protective shield 10a, 10b is properly positioned, the outer perimeter 14 of the shield 10a, b engages the ground surrounding the sprinkler 12. Moreover, the stiffening members 30 may additionally have downwardly protruding spikes or ground engaging members that prevent rotation of the protective shield 10a, 10b about the sprinkler 12.

When installed, the top of the sprinkler head 12 resides below the apex 28 of the upper surface 24 so that lawnmowers can ride over the protective shield 10a, 10b. People can visually spot the sprinkler head 13a, b and avoid stepping on the sprinkler head 13a, b. Also, if a person inadvertently steps on the protective shield 10a, 10b, the sprinkler head 13a, b is not damaged since the protective shield 10a, b would take the brunt of impact. The outer perimeter 14 engages the ground and lifts the lawnmower over and above the top of the sprinkler head 13a, b to protect the sprinkler head 13a, b from damage.

The protective shield 10a, b may be fabricated from a plastic material through a plastic injection molding process. The plastic material may be sufficiently soft to permit the installer to cut the inner peripheral portions 45 of the protective shields 10a, b or the body 26 adjacent to one of the stiffening members 30a, b, c, d with shears or scissors. Alternatively, the plastic material may be harder so that cutting the inner peripheral portion 45 of the protective shields 10a, b or the body 26 adjacent to one of the stiffening members 30a, b, c, d must be performed with a hack saw or other cutting mechanism. It is also contemplated that the shield 10a, 10b may be fabricated from other types of materials such as metal, aluminum, stainless steel, ceramics and composites.

The protective shield 10a, b disclosed herein may also be utilized in flower beds to prevent overgrowth of weeds and grass that if were allowed to grow over the sprinkler head would hinder proper operation of the sprinkler 12.

The above description is given by way of example, and not limitation. Given the above disclosure, one skilled in the art could devise variations that are within the scope and spirit of the invention disclosed herein, including various ways of forming the shield 10a, 10b. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A protective shield for a sprinkler head, the shield comprising a body having a upper surface, an outer perimeter of the upper surface being disposable at ground level, an inner perimeter of the upper surface being disposable below ground level, the upper surface of the shield having a donut configuration.

2. The shield of claim 1 wherein the body is fabricated from a rigid material that cm be cut with a scissors.

3. The shield of claim 2 wherein the body is fabricated from plastic.

4. The shield of claim 1 wherein body has a plurality of strengthening members on an underside thereof.

5. The shield of claim 1 wherein an inner peripheral portion of the body can be cut to size to fit larger diameter sized sprinkler heads.

6. The shield of claim 5 wherein an underside surface of the inner peripheral portion has one or more ring markings for assisting a person in cutting the inner peripheral portion to fit a body of a sprinkler.

7. The shield of claim 6 wherein the ring markings are grooves.

8. The shield of claim 1 wherein an outer peripheral portion of the body can be cut to abut the shield against a paved corner or sidewalk.

9. The shield of claim 1 wherein the upper surface of the body has a smooth curved configuration from the outer perimeter of the body to the inner perimeter of the body to form a donut configuration.

10. The shield of claim 1 wherein the upper surface of the body has a smooth carved configuration from the outer perimeter of the body to an apex of the smooth upper surface and has a cylindrical receiving volume at an interior of the shield.
